(19) United States
(12) Patent Application Publication
(10) Pub. No.: US 2016/0204960 A1
(43) Pub. Date: Jul. 14, 2016

(54) SOUNDING METHOD

(71) Applicant: NEWRACOM, INC., Irvine (KR)

(72) Inventor: Heejung YU, Daegu (KR)

(21) Appl. No.: 14/994,045

(22) Filed: Jan. 12, 2016

Related U.S. Application Data
(60) Provisional application No. 62/103,353, filed on Jan. 14, 2015.

(30) Foreign Application Priority Data
Dec. 21, 2015 (KR) 10-2015-0183129

(51) Int. Cl. H04L 25/02; H04W 72/04; H04L 5/00; H04B 7/04; H04B 7/06

(52) U.S. Cl. CPC H04L 25/0202; H04B 7/0417; H04B 7/063; H04B 7/0452; H04L 5/0007; H04W 72/0453; H04W 84/12

(57) ABSTRACT

A sounding method of a receiving device is provided. The receiving device receives an NDPA frame and then receives an NDP frame, from a transmitting device. After receiving the NDP frame, the receiving device transmits to the transmitting device a channel feedback frame including feedback information according to a feedback type indicated by the feedback type information.

### CROSS-REFERENCE TO RELATED APPLICATION

This application claims priority to and the benefit of U.S. Provisional Application No. 62/103,353, filed on Jan. 14, 2015 in the U.S. Patent and Trademark Office and priority to and the benefit of Korean Patent Application No. 10-2015-0183129, filed on Dec. 21, 2015 in the Korean Intellectual Property Office, the entire contents of which are incorporated herein by reference.

### BACKGROUND

(a) Field

The described technology relates generally to a sounding method. More particularly, the described technology relates generally to a sounding method in a wireless local area network (WLAN).

(b) Description of the Related Art

A WLAN is being standardized by the IEEE (Institute of Electrical and Electronics Engineers) Part 11 under the name of “Wireless LAN Medium Access Control (MAC) and Physical Layer (PHY) Specifications.”

After an original standard was published in 1999, new version standards are continuously published by amendments. The IEEE standard 802.11a (IEEE Std 802.11a-1999) supporting 5 GHz band and the IEEE standard 802.11b (IEEE Std 802.11b-1999) supporting 2.4 GHz band were published in 1999, and the IEEE standard 802.11g (IEEE Std 802.11g-2003) supporting 2.4 GHz band was published in 2003. These standards are called legacy. Subsequently, the IEEE standard 802.11n (IEEE Std 802.11n-2009) for enhancements for higher throughput (HT) was published in 2009, and the IEEE standard 802.11ac (IEEE 802.11ac-2013) for enhancements for very high throughput (VHT) was published in 2013.

Recently, a high efficiency (HE) WLAN for enhancing the system throughput in high density scenarios is being developed by the IEEE 802.11ax task group. The HE WLAN or a subsequent WLAN may use a multi-user transmission. For example, the HE WLAN or the subsequent WLAN may enhance the system throughput by using a scheme such as orthogonal frequency division multiple access (OFDMA) or multiple input multiple output (MIMO). A channel sounding procedure where a transmitting device acquires channel information is required for enhancing the system throughput.

### SUMMARY

An embodiment provides a sounding method for multi-user transmission.

According to an embodiment, a sounding method of a receiving device is provided. The method includes receiving a null data packet announcement (NDPA) frame including feedback type information from a transmitting device, receiving a null data packet (NDP) frame from the transmitting device after receiving the NPDA frame, and transmitting to the transmitting device a channel feedback frame including feedback information according to a feedback type indicated by the feedback type information after receiving the NDP frame.

The NDPA frame may further include grouping information indicating how many subcarriers are grouped to be fed back as single information.

When the grouping information indicates that N subcarriers are grouped to be fed back as the single information, in a long training field of the NDP frame, a value for the long training field may be transmitted through only one subcarrier among the N subcarriers.

When the grouping information indicates that N subcarriers are grouped to be fed back as the single information, in a long training field of the NDP frame, values for different transmitting antennas may be transmitted through the Ng subcarriers, respectively.

The NDPA frame may further include size information of a fast Fourier transform (FFT) used in a part of the NDP frame or length information of a guard interval used in the part of the NDP frame.

The part of the NDP frame may include a long training field of the NDP frame.

The NDPA frame may further include codebook information. In this case, the feedback information may include beamforming feedback matrix information that is provided in a form of angles that are determined based on a quantization level indicated by the codebook information, and the beamforming feedback matrix information may be used for determining a matrix for multiple input multiple output (MIMO) transmission.

When the feedback type indicated by the feedback type information is OFDMA transmission, the feedback information, when a predetermined band is divided into a plurality of subchannels, may include an average signal-to-noise ratio (SNR) for each of the subchannels.

In this case, the method may further include receiving from the transmitting device a second NDPA frame including feedback type information indicating MIMO transmission, receiving a second NDP frame from the transmitting device after receiving the second NPDA frame, and transmitting to the transmitting device a second channel feedback frame including feedback information for the MIMO transmission after receiving the second NDP frame. The feedback information may include beamforming feedback matrix information at a subchannel that is allocated to the receiving device among the plurality of subchannels, and the beamforming feedback matrix information may be used for determining a matrix for the MIMO transmission.

When the MIMO transmission is multi-user MIMO (MU-MIMO) transmission, the feedback information may further include SNR information per subcarrier for each stream, and the matrix for the MU-MIMO transmission may be determined based on the beamforming feedback matrix information and the SNR information per subcarrier.

The second NDP frame may include information on a subchannel allocated to the receiving device.

When the feedback type indicated by the feedback type information is OFDMA and MIMO transmission, the feedback information, when a predetermined band is divided into a plurality of subchannels, may include an average SNR for each subchannel and beamforming feedback matrix information for each subchannel, and the beamforming feedback matrix information may be used for a matrix for the MIMO transmission.

When the MIMO transmission is MU-MIMO transmission, the feedback information may further include SNR information per subcarrier for each stream, and the matrix for the MU-MIMO transmission may be determined based on the beamforming feedback matrix information and the SNR information per subcarrier.

According to another embodiment, a sounding method of a transmitting device is provided. The method includes transmitting to a plurality of receiving devices an NDPA frame including a plurality of feedback type information, transmitting an NDP frame to the plurality of devices after transmitting the NPDA frame, and receiving from the plurality of receiving devices channel feedback frames, each of the channel feedback frames including feedback information according to a feedback type indicated by corresponding feedback type information.

The NDPA frame may further include grouping information indicating how many subcarriers are grouped to be fed back as single information.

The NDPA frame may further include size information of an FFT used in a part of the NDP frame or length information of a guard interval used in the part of the NDP frame.

The NDPA frame may further include a plurality of codebook information respectively corresponding to the plurality of receiving devices. In this case, the feedback information may include beamforming feedback matrix information that is provided in a form of angles that are determined based on a quantization level indicated by a corresponding codebook information among the plurality of codebook information, and the beamforming feedback matrix information may be used for determining a matrix for multiple input multiple output (MIMO) transmission.

When the feedback type indicated by the corresponding feedback type information is OFDMA transmission, the feedback information, when a predetermined band is divided into a plurality of subchannels, may include an average SNR for each of the subchannels.

In this case, the method may further include transmitting to the plurality of receiving devices a second NDPA frame including feedback type information indicating MIMO transmission, transmitting a second NDP frame to the plurality of receiving devices after transmitting the second NPDA frame, and receiving from the plurality of receiving devices second channel feedback frames each including feedback information for the MIMO transmission. The feedback information may include beamforming feedback matrix information at a subchannel that is allocated to a corresponding receiving device among the plurality of subchannels, and the beamforming feedback matrix information may be used for determining a matrix for the MIMO transmission.

When the feedback type indicated by the corresponding feedback type information is OFDMA and MIMO transmission, the feedback information, when a predetermined band is divided into a plurality of subchannels, may include an average SNR for each subchannel and beamforming feedback matrix information for each subchannel, and the beamforming feedback matrix information may be used for a matrix for the MIMO transmission.

According to yet another embodiment, a sounding apparatus of a receiving device is provided. The sounding apparatus includes a processor and a transceiver. The transceiver receives an NDPA frame including feedback type information from a transmitting device and receives an NDP frame from the transmitting device after receiving the NPDA frame. The processor generates a channel feedback frame including feedback information according to a feedback type indicated by the feedback type information after receiving the NDP frame. The transceiver transmits the channel feedback frame to the transmitting device.

According to still another embodiment, a sounding apparatus of a transmitting device is provided. The sounding apparatus includes a processor and a transceiver. The processor generates an NDPA frame including a plurality of feedback type information. The transceiver transmits an NDP frame to a plurality of receiving devices after transmitting the NDPA frame to the plurality of receiving devices, and receives from the plurality of receiving devices channel feedback frames, each of the channel feedback frames including feedback information according to a feedback type indicated by corresponding feedback type information.

### BRIEF DESCRIPTION OF THE DRAWINGS

FIG. 1 is a schematic block diagram of a WLAN device according to an embodiment.

FIG. 2 is a schematic block diagram of a transmitting signal processor in an embodiment suitable for use in a WLAN.

FIG. 3 is a schematic block diagram of a receiving signal processing unit in an embodiment suitable for use in the WLAN.

FIG. 4 shows Inter-Frame Space (IFS) relationships

FIG. 5 is a schematic diagram showing a CSMA/CA based frame transmission procedure for avoiding collision between frames in a channel.

FIG. 6 shows an example of a wireless communication network according to an embodiment.

FIG. 7 shows a sounding procedure in a wireless communication network according to an embodiment.

FIG. 8 shows a sounding procedure in a wireless communication network according to another embodiment.

FIG. 9 shows an example of the first NDPA frame shown in FIG. 7.

FIG. 10 shows an example of the second NDPA frame shown in FIG. 7.

FIG. 11 shows an example of an NDPA frame shown in FIG. 8.

FIG. 12 shows a frame structure in a wireless communication network according to an embodiment.

FIG. 13 shows another example of the first NDPA frame shown in FIG. 7.

FIG. 14 shows another example of the second NDPA frame shown in FIG. 7.

FIG. 15 shows another example of an NDPA frame shown in FIG. 8.

FIG. 16 shows an example of an NDP frame shown in FIG. 7 or FIG. 8.

FIG. 17 shows an example of subcarriers used in a HE-LTF in a case that Ng is 1 in an NDP frame shown in FIG. 16.

FIG. 18 shows an example of subcarriers used in a HE-LTF in a case that Ng is 2 in an NDP frame shown in FIG. 16.

FIG. 19 shows another example of subcarriers used in a HE-LTF in a case that Ng is 2 in an NDP frame shown in FIG. 16.

FIG. 20 shows another example of an NDP frame shown in FIG. 7 or FIG. 8.

FIG. 21 shows an example of a CFB frame when a feedback type indicates OFDMA.

FIG. 22 shows an example of a CFB frame when a feedback type indicates SU-MIMO.

FIG. 23 shows an example of a CFB frame when a feedback type indicates MU-MIMO.

FIG. 24 shows an example of a CFB frame when a feedback type indicates OFDMA+SU-MIMO.

FIG. 25 shows an example of a CFB frame when a feedback type indicates OFDMA+MU-MIMO.

### DETAILED DESCRIPTION OF THE EMBODIMENTS

In the following detailed description, only certain embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

In a wireless local area network (WLAN), a basic service set (BSS) includes a plurality of WLAN devices. The WLAN device may include a medium access control (MAC) layer and a physical (PHY) layer according to the IEEE (Institute of Electrical and Electronics Engineers) standard 802.11. The plurality of WLAN devices may include a WLAN device that is an access point and the other WLAN devices that are non-AP stations (non-AP STAs). Alternatively, all of the plurality of WLAN devices may be non-AP STAs in ad-hoc networking. In general, the AP STA and the non-AP STA may be collectively called the STAs. However, for ease of description, herein, only the non-AP STA are referred to as the STAs.

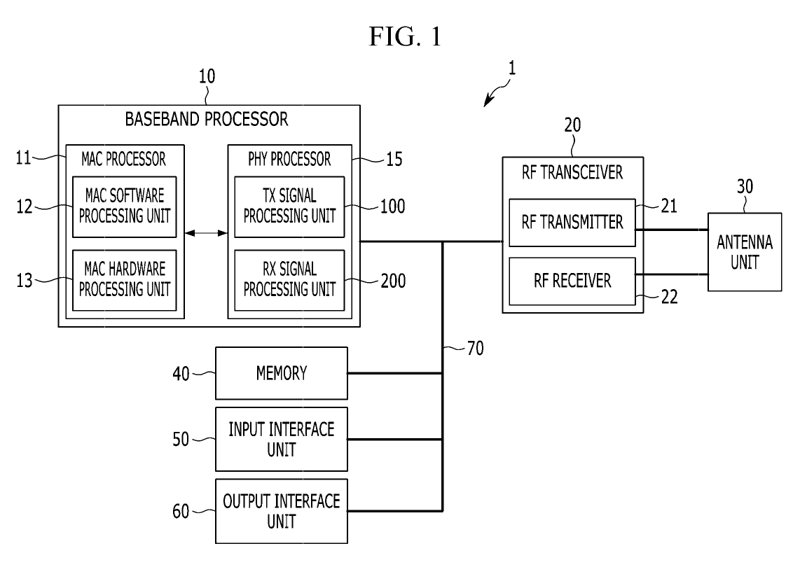

FIG. 1 is a schematic block diagram exemplifying a WLAN device according to an embodiment.

Referring to FIG. 1, the WLAN device 1 includes a baseband processor 10, a radio frequency (RF) transceiver 20, an antenna unit 30, a memory 40 including non-transitory computer-readable media, an input interface unit 50, an output interface unit 60 and a bus 70.

The baseband processor 10 performs baseband signal processing and includes a MAC processor 11 and a PHY processor 15.

In one embodiment, the MAC processor 11 may include a MAC software processing unit 12 and a MAC hardware processing unit 13. The memory 40 may store software (hereinafter referred to as “MAC software”) including at least some functions of the MAC layer. The MAC software processing unit 12 executes the MAC software to implement the some functions of the MAC layer and the MAC hardware processing unit 13 may implement remaining functions of the MAC layer as hardware (hereinafter referred to “MAC hardware”). However, the MAC processor 11 is not limited to this.

The PHY processor 15 includes a transmitting (Tx) signal processing unit 100 and a receiving (Rx) signal processing unit 200.

The baseband processor 10, the memory 40, the input interface unit 50 and the output interface unit 60 may communicate with each other via the bus 70.

The RF transceiver 20 includes an RF transmitter 21 and an RF receiver 22.

The memory 40 may further store an operating system and applications. The input interface unit 50 receives information from a user and the output interface unit 60 outputs information to the user.

The antenna unit 30 includes one or more antennas. When multiple-input multiple-output (MIMO) or multi-user MIMO (MU-MIMO) is used, the antenna unit 30 may include a plurality of antennas.

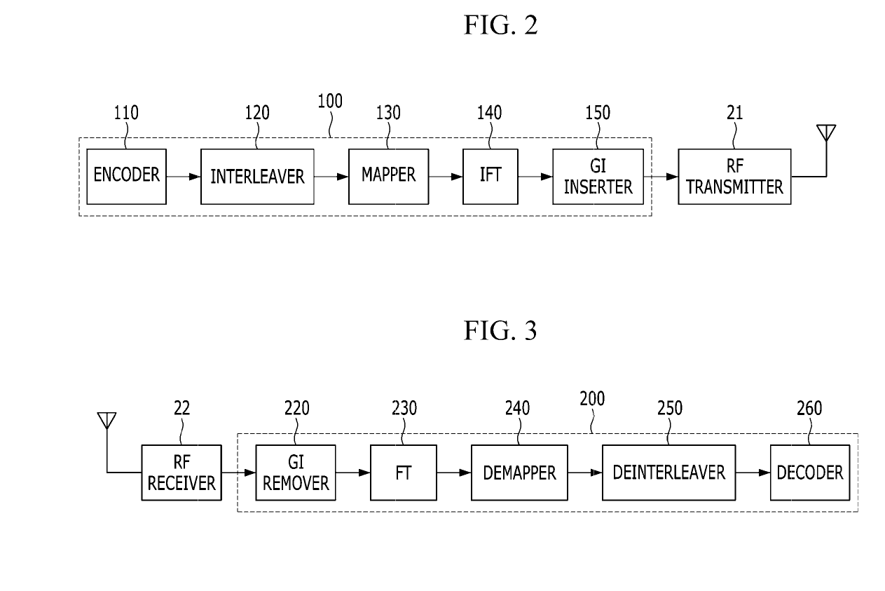

FIG. 2 is a schematic block diagram of a transmitting signal processor 100 in an embodiment suitable for use in a WLAN.

Referring to FIG. 2, a transmitting signal processing unit 100 includes an encoder 110, an interleaver 120, a mapper 130, an inverse Fourier transformer (IFT) 140 and a guard interval (GI) inserter 150.

The encoder 110 encodes input data. For example, the encoder 100 may be a forward error correction (FEC) encoder. The FEC encoder may include a binary convolutional code (BCC) encoder followed by a puncturing device, or may include a low-density parity-check (LDPC) encoder.

The transmitting signal processing unit 100 may further include a scrambler for scrambling the input data before the encoding to reduce the probability of long sequences of 0s or 1s. If BCC encoding is used in the encoder, the transmitting signal processing unit 100 may further include an encoder parser for demultiplexing the scrambled bits among a plurality of BCC encoders. If LDPC encoding is used in the encoder, the transmitting signal processing unit 100 may not use the encoder parser.

The interleaver 120 interleaves the bits of each stream output from the encoder to change an order of bits. Interleaving may be applied only when BCC encoding is used. The mapper 130 maps the sequence of bits output from the interleaver to constellation points. If the LDPC encoding is used in the encoder, the mapper 130 may further perform LDPC tone mapping besides the constellation mapping.

When the MIMO or the MU-MIMO is used, the transmitting signal processing unit 100 may use a plurality of interleavers 120 and a plurality of mappers 130 corresponding to a number of spatial streams N_{SS}. In this case, the transmitting signal processing unit 100 may further include a stream parser for dividing outputs of the BCC encoders or the LDPC encoder into blocks that are sent to different interleavers 120 or mappers 130. The transmitting signal processing unit 100 may further include a space-time block code (STBC) encoder for spreading the constellation points from the N_{SS} spatial streams into N_{STS} space-time streams and a spatial mapper for mapping the space-time streams to transmit chains. The spatial mapper may use direct mapping, spatial expansion, or beamforming.

The IFT 140 converts a block of the constellation points output from the mapper 130 or the spatial mapper to a time domain block (i.e., a symbol) by using an inverse discrete Fourier transform (IDFT) or an inverse fast Fourier transform (IFFT). If the STBC encoder and the spatial mapper are used, the inverse Fourier transformer 140 may be provided for each transmit chain.

When the MIMO or the MU-MIMO is used, the transmitting signal processing unit 100 may insert cyclic shift diversities (CSDs) to prevent unintentional beamforming. The CSD insertion may occur before or after the inverse Fourier transform. The CSD may be specified per transmit chain or may be specified per space-time stream. Alternatively, the CSD may be applied as a part of the spatial mapper.

When the MU-MIMO is used, some blocks before the spatial mapper may be provided for each user.

The GI inserter 150 prepends a guard interval (GI) to the symbol. The transmitting signal processing unit 100 may optionally perform windowing to smooth edges of each symbol after inserting the GI. The RF transmitter 21 converts the symbols into an RF signal and transmits the RF signal via the antenna unit 30. When the MIMO or the MU-MIMO is used, the GI inserter 150 and the RF transmitter 21 may be provided for each transmit chain.

FIG. 3 is a schematic block diagram of a receiving signal processing unit according to an embodiment suitable for use in the WLAN.

Referring to FIG. 3, a receiving signal processing unit 200 includes a GI remover 220, a Fourier transformer (FT) 230, a demapper 240, a deinterleaver 250 and a decoder 260.

An RF receiver 22 receives an RF signal via the antenna unit 30 and converts the RF signal into a symbol. The GI remover 220 removes the GI from the symbol. When the MIMO or the MU-MIMO is used, the RF receiver 22 and the GI remover 220 may be provided for each receive chain.

The FT 230 converts the symbol (i.e., the time domain block) into a block of the constellation points by using a discrete Fourier transform (DFT) or a fast Fourier transform (FFT). The Fourier transformer 230 may be provided for each receive chain.

When the MIMO or the MU-MIMO is used, the receiving signal processing unit 200 may include a spatial demapper for converting the Fourier transformed received symbols to constellation points of the space-time streams and an STBC decoder for despreading the constellation points from the space-time streams into the spatial streams.

The demapper 240 demaps the constellation points output from the Fourier transformer 230 or the STBC decoder to the bit streams. If the LDPC encoding is used, the demapper 240 may further perform LDPC tone demapping before the constellation demapping. The deinterleaver 250 deinterleaves the bits of each stream output from the demapper 240. Deinterleaving may be applied only when BCC encoding is used.

When the MIMO or the MU-MIMO is used, the receiving signal processing unit 200 may use a plurality of demappers 240 and a plurality of deinterleavers 250 corresponding to the number of spatial streams. In this case, the receiving signal processing unit 200 may further include a stream deparser for combining the streams output from the deinterleavers 250.

The decoder 260 decodes the streams output from the deinterleaver 250 or the stream deparser. For example, the decoder 100 may be an FEC decoder. The FEC decoder may include a BCC decoder or an LDPC decoder. The receiving signal processing unit 200 may further include a descrambler for descrambling the decoded data. If BCC decoding is used in the decoder, the receiving signal processing unit 200 may further include an encoder deparser for multiplexing the data decoded by a plurality of BCC decoders. If LDPC decoding is used in the decoder, the receiving signal processing unit 100 may not use the encoder deparser.

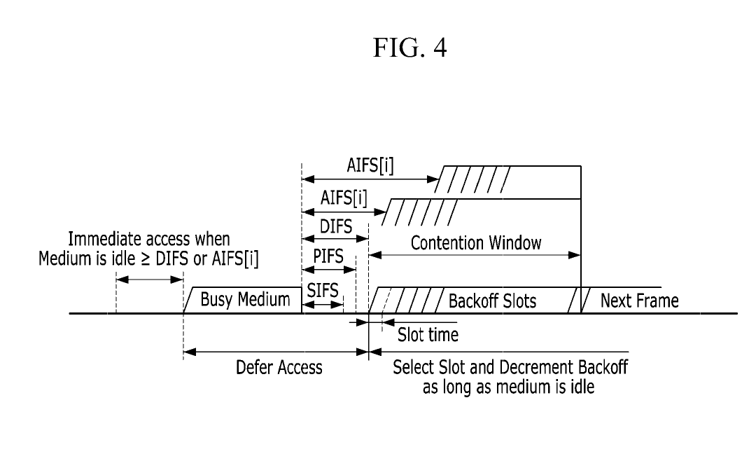

FIG. 4 illustrates interframe space (IFS) relationships.

A data frame, a control frame, or a management frame may be exchanged between WLAN devices.

The data frame is used for transmission of data forwarded to a higher layer. The WLAN device transmits the data frame after performing backoff if a distributed coordination function IFS (DIFS) has elapsed from a time when the medium has been idle. The management frame is used for exchanging management information which is not forwarded to the higher layer. Subtype frames of the management frame include a beacon frame, an association request/response frame, a probe request/response frame and an authentication request/response frame. The control frame is used for controlling access to the medium. Subtype frames of the control frame include a request to send (RTS) frame, a clear to send (CTS) frame and an acknowledgement (ACK) frame. When the control frame is not a response frame of a previous frame, the WLAN device transmits the control frame after performing backoff when the DIFS has elapsed. When the control frame is the response frame of a previous frame, the WLAN device transmits the control frame without performing backoff when a short IFS (SIFS) has elapsed. The type and subtype of a frame may be identified by a type field and a subtype field in a frame control field.

On the other hand, a Quality of Service (QoS) STA may transmit the frame after performing backoff when an arbitration IFS (AIFS) for access category (AC), i.e., AIFS[AC], has elapsed. In this case, the data frame, the management frame, or the control frame which is not the response frame may use the AIFS[AC].

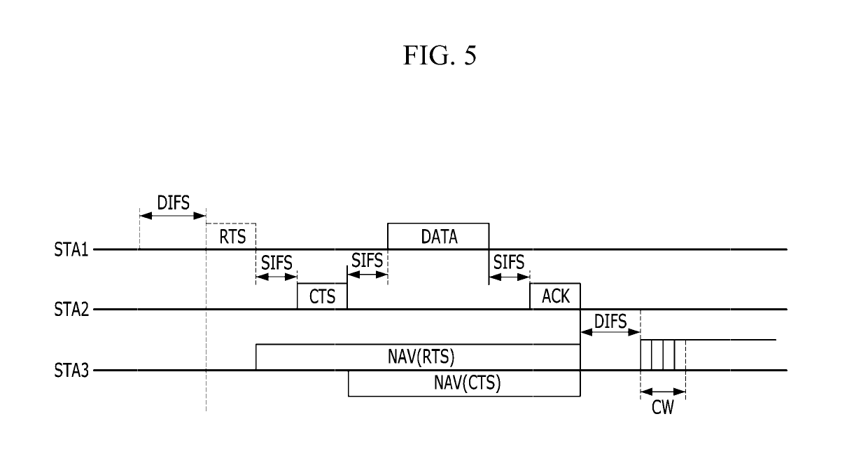

FIG. 5 is a schematic diagram illustrating a CSMA (carrier sense multiple access)/CA (collision avoidance) based frame transmission procedure for avoiding collision between frames in a channel.

Referring to FIG. 5, STA1 is a transmit WLAN device for transmitting data, STA2 is a receive WLAN device for receiving the data and STA3 is a third WLAN device which may be located at an area where a frame transmitted from the STA1 and/or a frame transmitted from the STA2 can be received by the third WLAN device.

The STA1 may determine whether the channel is busy by carrier sensing. The STA1 may determine the channel occupation based on an energy level on the channel or correlation of signals in the channel, or may determine the channel occupation by using a network allocation vector (NAV) timer.

When it is determined that the channel is not in use by other devices during DIFS (that is, that the channel is idle), the STA1 may transmit an RTS frame to the STA2 after performing backoff. Upon receiving the RTS frame, the STA2 may transmit a CTS frame as a response of the CTS frame after a SIFS.

When the STA3 receives the RTS frame, it may set the NAV timer for a transmission duration of subsequently transmitted frames (for example, a duration of SIFS+CTS frame duration+SIFS+data frame duration+SIFS+ACK frame duration) by using duration information included in the RTS frame. For example, the NAV timer may be set for a duration of SIFS+CTS frame duration+SIFS+data frame duration+SIFS+ACK frame duration. When the STA3 receives the CTS frame, it may set the NAV timer for a transmission duration of subsequently transmitted frames (for example, a duration of SIFS+data frame duration+SIFS+ACK frame duration) by using duration information included in the RTS CTS frame. For example, the NAV timer may be set for a duration of SIFS+data frame duration+SIFS+ACK frame duration. Upon receiving a new frame before the NAV timer expires, the STA3 may update the NAV timer by using duration information included in the new frame. The STA3 does not attempt to access the channel until the NAV timer expires.

When the STA1 receives the CTS frame from the STA2, it may transmit a data frame to the STA2 after SIFS elapses from a time when the CTS frame has been completely received. Upon successfully receiving the data frame, the STA2 may transmit an ACK frame as a response of the data frame after a SIFS elapses.

When the NAV timer expires, the STA3 may determine whether the channel is busy by the carrier sensing. Upon determining that the channel is not in use by the other devices during DIFS after the NAV timer has expired, the STA3 may attempt the channel access after a contention window according to random backoff elapses.

Now, a sounding method in a wireless communication network according to an embodiment is described with reference to the drawings.

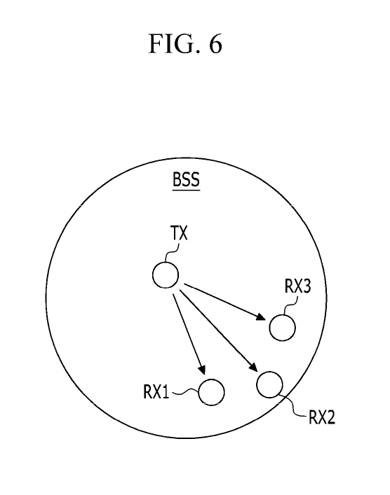

FIG. 6 shows an example of a wireless communication network according to an embodiment.

Referring to FIG. 6, a basic service set (BSS) includes a plurality of WLAN devices. In the plurality of WLAN devices, a device TX may be a transmitting device and devices RX1, RX2, and RX3 may be receiving devices. The three receiving devices RX1, RX2, and RX3 are exemplified in FIG. 6 for convenience, but the number of the receiving devices RX1, RX2, and RX3 is not limited thereto.

The transmitting device TX and the receiving devices RX1, RX2, and RX3 support a wireless communication network according to an embodiment

For example, the wireless communication network according to an embodiment may be a high efficiency (HE) WLAN developed by the IEEE 802.11ax task group. A device supporting the HE WLAN is referred to as a “HE device.”

Hereinafter, it is assumed for convenience that the wireless communication network according to an embodiment is a HE WLAN.

In some embodiments, the transmitting device TX may be an AP and the receiving devices RX1, RX2, and RX3 may be non-AP STAs.

In some embodiments, the transmitting device TX may transmit a frame using single user MIMO (SU-MIMO) or multi-user MIMO (MU-MIMO). The transmitting device TX may transmit a PHY frame, for example a PHY protocol data unit (PPDU), using a beamforming steering matrix. In this case, the receiving devices RX1, RX2, and RX3 may receive the transmitted frame, for example the PPDU, using the beamforming steering matrix.

In some embodiments, the transmitting device TX may transmit the frame by combining the SU-MIMO or the MU-MIMO with an OFDMA transmission. That is, the transmitting device TX may divide a predetermined band into a plurality of subbands (i.e., subchannels) and allocate the receiving device for each subchannel. In one embodiment, one subchannel may be allocated to one receiving device. In another embodiment, two or more subchannels may be allocated to one receiving device, or one subchannel may be allocated to two or more devices.

The BSS may further include a previous version device. The previous version device may be, for example, a device (hereinafter referred to as a “legacy device”) supporting the IEEE standard 802.11a, 802.11b or 802.11g (IEEE Std 802.11a-1999, IEEE Std 802.11b-1999 or IEEE Std 802.11g-2003), a device (hereinafter referred to as an “HT device”) supporting the IEEE standard 802.11n (IEEE Std 802.11n-2009) for enhancements for higher throughput (HT), or a device (hereinafter referred to as a “VHT device”) supporting the IEEE standard 802.11ac (IEEE Std 802.11ac-2013) for enhancements for very high throughput (VHT).

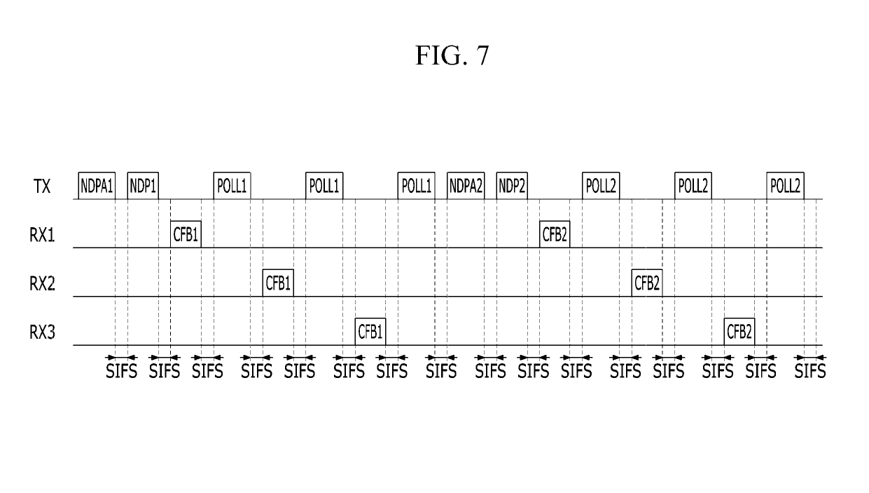

FIG. 7 shows a sounding procedure in a wireless communication network according to an embodiment.

Referring to FIG. 7, a transmitting device TX performs a sounding procedure for determining a subchannel to be used by each receiving device. The transmitting device TX transmits a null data packet announcement (NDPA) frame NDPA1 to receiving devices RX1, RX2, and RX3, and then transmits a null data packet (NDP) frame NDP1 to the receiving devices RX1, RX2, and RX3 after a predetermined IFS interval. In some embodiments, the predetermined IFS interval may a SIFS interval. Hereinafter, it is assumed for convenience that the predetermined IFS is the SIFS interval.

The first receiving device RX1 among the plurality of receiving devices RX1, RX2, and RX3 receiving the NDP frame NPD1 feeds a channel feedback (CFB) frame CFB1 back to the transmitting device TX as a response of the NDP frame NPD1 after a SIFS interval. For example, the feedback frame may be a compressed beamforming (CB) frame. The transmitting device TX receiving the CFB frame CFB1 from the receiving device RX1 transmits a beamforming report poll (BR-poll) frame Poll1 to the second receiving device RX2 after the SIFS interval. The receiving device RX2 receiving the BR-poll frame Poll1 feeds a CFB frame CFB1 back to the transmitting device TX as a response of the BR-poll frame Poll1 after the SIFS interval. The transmitting device TX receiving the CFB frame CFB1 from the receiving device RX2 transmits a BR-poll frame Poll1 to the third receiving device RX3 after the SIFS interval. The receiving device RX3 receiving the BR-poll frame Poll1 feeds a CFB frame CFB1 back to the transmitting device TX as a response of the BR-poll frame Poll1 after the SIFS interval.

In some embodiments, the CFB frame CFB1 transmitted by each receiving device includes feedback information. The feedback information may include subchannel information that is measured for each subchannel. In one embodiment, the subchannel information of each subchannel may include an average signal-to-noise ratio (SNR) of each subchannel.

Transmitting device TX may determine a subchannel to be used by each receiving device based on the feedback information provided by each receiving device through the CFB frame CFB1, for example the subchannel information of each subchannel. After determining the subchannel to be used by each receiving device, the transmitting device TX performs a sounding procedure for MIMO transmission.

The transmitting device TX transmits an NDPA frame NDPA2 to receiving devices RX1, RX2, and RX3 again, and then transmits an NDP frame NDP2 to the receiving devices RX1, RX2, and RX3 after a SFS interval. The first receiving device RX1 among the plurality of receiving devices RX1, RX2, and RX3 receiving the NDP frame NPD2 feeds a CFB frame CFB2 back to the transmitting device TX as a response of the NDP frame NPD2 after the SIFS interval. The transmitting device TX receiving the CFB frame CFB2 from the receiving device RX1 transmits a BR-poll frame Poll2 to the second receiving device RX2 after the SIFS interval. The receiving device RX2 receiving the BR-poll frame Poll2 feeds a CFB frame CFB2 back to the transmitting device TX as a response of the BR-poll frame Poll1 after the SIFS interval. The transmitting device TX receiving the CFB frame CFB2 from the receiving device RX2 transmits a BR-poll frame Poll2 to the third receiving device RX3 after the SIFS interval. The receiving device RX3 receiving the BR-poll frame Poll2 feeds a CFB frame CFB2 back to the transmitting device TX as a response of the BR-poll frame Poll2 after the SIFS interval.

In some embodiments, the CFB frame CFB2 may include information necessary for the MIMO information as feedback information. In one embodiment, the information necessary for the MIMO information may include channel matrix information for the MIMO transmission. Then, the transmitting device TX may determine a matrix (for example, a steering matrix) for using the MIMO transmission based on the CFB frames CFB2 from the receiving devices RX1, RX2, and RX3. The transmitting device TX may determine a modulation and coding scheme (MCS) for using the MIMO transmission based on the CFB frames CFB2.

In some embodiments, on a subchannel allocated to two or more receiving devices, a sounding procedure for MU-MIMO transmission may be performed between the transmitting device TX and the two or more receiving devices allocated on the subchannel. On a subchannel allocated to one receiving device, a sounding procedure for SU-MIMO transmission may be performed between the transmitting device TX and the receiving device allocated on the subchannel.

As such, according to an embodiment, after the sounding for the subchannel allocation is performed, the sounding for the MIMO transmission can be performed based on the allocated subchannels.

In some embodiments, since the subchannel allocation is not performed when OFDM transmission is used, the second sounding procedure (the sounding procedure for the MIMO transmission) may be performed without the first sounding procedure (the sounding procedure for the subchannel allocation).

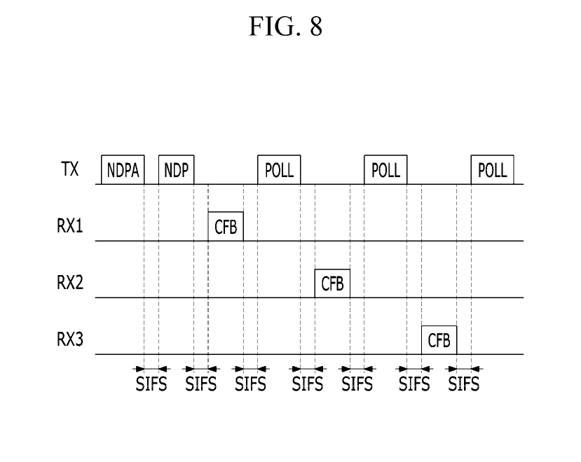

FIG. 8 shows a sounding procedure in a wireless communication network according to another embodiment.

Referring to FIG. 8, a transmitting device TX transmits an NDPA frame to receiving devices RX1, RX2, and RX3, and then transmits an NDP frame to receiving devices RX1, RX2, and RX3 after a SIFS interval. The first receiving device RX1 among the plurality of receiving devices RX1, RX2, and RX3 receiving the NDP frame NPD feeds a CFB frame back to the transmitting device TX as a response of the NDP frame NPD1 after the SIFS interval. The transmitting device TX receiving the CFB frame from the receiving device RX1 transmits a BR-poll frame to the second receiving device RX2 after the SIFS interval. The receiving device RX2 receiving the BR-poll frame feeds a CFB frame back to the transmitting device TX as a response of the BR-poll frame after the SIFS interval. The transmitting device TX receiving the CFB frame from the receiving device RX2 transmits a BR-poll frame to the third receiving device RX3 after the SIFS interval. The receiving device RX3 receiving the BR-poll frame feeds a CFB frame back to the transmitting device TX as a response of the BR-poll frame Poll2 after the SIFS interval.

In some embodiments, the CFB frame transmitted by each receiving device includes feedback information. The feedback information may include subchannel information measured for each subchannel and information necessary for the MIMO information. In one embodiment, the subchannel information of each subchannel may include an average SNR of each subchannel, and the information necessary for the MIMO information may include channel matrix information for the MIMO transmission.

Then, the transmitting device TX may determine a subchannel to be used by each receiving and a matrix (for example, a steering matrix) for using the MIMO transmission based on the CFB frames from the receiving devices RX1, RX2, and RX3. The transmitting device TX may determine an MCS for using the MIMO transmission based on the CFB frames.

In some embodiments, the receiving device may feed information for the MU-MIMO back on a subchannel allocated to two or more receiving devices, and may feed information for the SU-MIMO back on a subchannel allocated to one receiving device.

As such, according to the present embodiment, the sounding for the subchannel allocation and the sounding for the MIMO transmission can be performed through a unified sounding procedure.

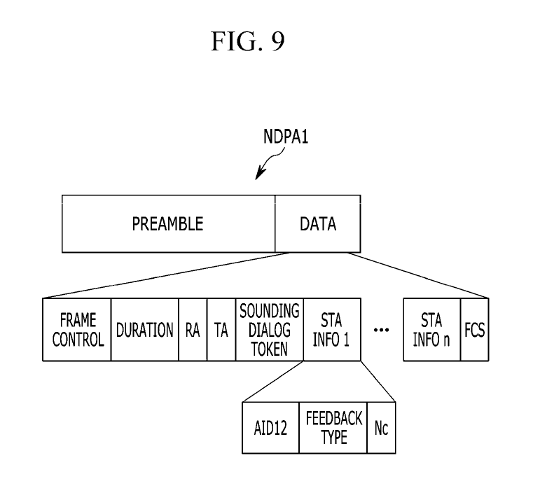

Next, an NDPA frame according to an embodiment in a wireless communication network is described with reference to FIG. 9 to FIG. 15.

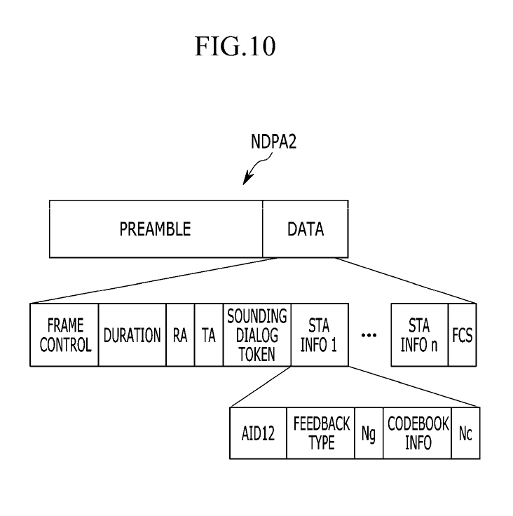

FIG. 9 shows an example of the first NDPA frame shown in FIG. 7 and FIG. 10 shows an example of the second NDPA frame shown in FIG. 7.

Referring to FIG. 9 and FIG. 10, an NDPA frame includes a preamble and a data field.

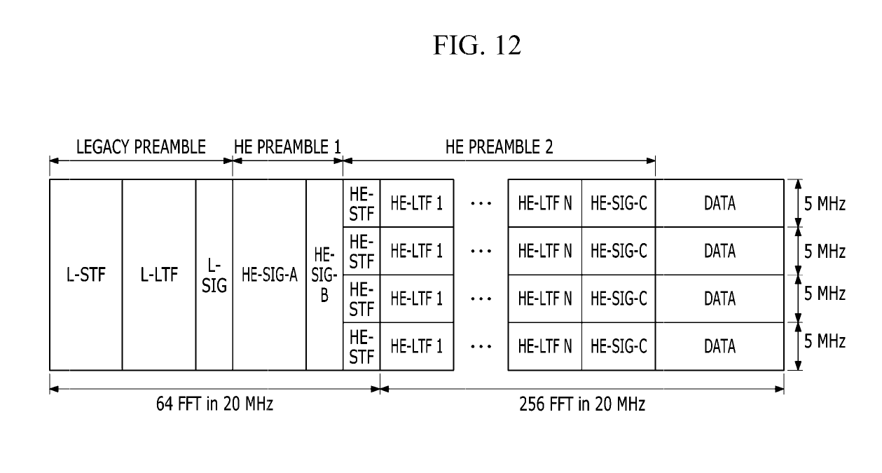

In some embodiments, the NDPA frame may have a legacy frame format. In this case, the preamble includes a legacy short training field (L-STF), a legacy long training field (L-LTF), and a legacy signal field (L-SIG). In another embodiment, the NDPA frame may have a HE frame format to be described with reference to FIG. 12.

A MAC frame is inserted to the data field, and the MAC frame includes a MAC header and a frame body field. The frame body field includes a station information field (STA Info). When a plurality of receiving devices (e.g., station), the frame body field includes a plurality of station information fields STA Info 1 to STA Info n corresponding to the plurality of receiving devices respectively.

Referring to FIG. 9, each station information field (STA Info) in the first NDPA frame (NDPA1 of FIG. 7) includes identification information of a corresponding receiving device and a feedback type.

The identification information of the receiving device may include some bits of an association identifier (AID), for example some LSBs (least significant bits) of the AID, of the receiving device. In some embodiments, the some LSBs of the AID may be 12 LSBs (AID12) of the AID.

The feedback type may indicate any one of OFDMA, SU-MIMO, and MU-MIMO. In the sounding procedure shown in FIG. 7, the feedback type of the first NDPA frame (NDPA1) may be set to a value indicating the OFDMA.

When the feedback type indicates the MU-MIMO, each station information field (STA Info) may further include an Nc index. The Nc index indicates the number (Nc) of columns to be used in a compressed beamforming feedback matrix. For example, the Nc index may be set to the number (Nc) of columns minus one.

In some embodiments, the compressed beamforming feedback matrix is a matrix for use by a transmitting device to determine a steering matrix, i.e., a MIMO matrix, and may be provided in the form of angles (ψ, φ) representing the compressed beamforming feedback matrices. In some embodiments, the compressed beamforming feedback matrix may use a compressed beamforming feedback matrix defined in the IEEE standard 802.11ac.

Referring to FIG. 10, each station information field (STA Info) in the second NDPA frame (NDPA2 of FIG. 7) includes identification information of a corresponding receiving device, a feedback type, grouping information, and codebook information.

The identification information of the receiving device may include some bits of an AID of the receiving device. The feedback type may indicate any one of OFDMA, SU-MIMO, and MU-MIMO. In the sounding procedure shown in FIG. 7, the feedback type of the second NDPA frame (NDPA2) may be set to a value indicating the SU-MIMO or the MU-MIMO.

When the feedback type indicates the MU-MIMO, each station information field (STA Info) may further include an Nc index. The Nc index indicates the number (Nc) of columns to be used in a compressed beamforming feedback matrix.

The grouping information may be information representing how many subcarriers are grouped to be fed back as single information. That is, the grouping information may indicate the number Ng of subcarriers used for the compressed beamforming feedback matrix, i.e., the number Ng of subcarriers included in one group. In some embodiments, Ng equal to 1 may indicate no grouping, Ng equal to 2 may indicate that two subcarriers are grouped into one group, and Ng equal to 4 may indicate that four subcarriers are grouped into one group.

The codebook information indicates information on a quantization level of angle information in the compressed beamforming feedback matrix. In some embodiments, the codebook information may indicate the size of codebook entries including two angle information ψ and φ. For example, when the feedback type indicates the SU-MIMO, the codebook information set to 0 may indicate 2 bits for the angle ψ and 4 bits for the angle φ, and the codebook information set to 1 may indicate 4 bits for the angle ψ and 6 bits for the angle φ. When the feedback type indicates the MU-MIMO, the codebook information set to 0 may indicate 5 bits for the angle ψ and 7 bits for the angle φ, and the codebook information set to 1 may indicate 7 bits for the angle ψ and 9 bits for the angle φ.

According to an embodiment, the NDPA frame transmitted by the transmitting device TX can provide the grouping information or codebook information. When determining beams toward receiving devices RX1, RX2, and RX3 for the MIMO transmission, the transmitting device TX determines the beam toward each receiving device in consideration of channels with all of the receiving devices RX1, RX2, and RX3. Differently from an embodiment, the receiving devices RX1, RX2, and RX3 may provide the grouping information or the codebook information. In this case, if the first receiving device RX1 among the receiving devices RX1, RX2, and RX3 determines to increase Ng and use few bits in the codebook because its channel condition is bad, the determination of the receiving device RX1 may apply to the other receiving devices RX2 and RX3. Accordingly, a signal which the transmitting device TX transmits to the receiving device RX1 by the beam determined by inaccurate information may act interference on the other receiving devices RX2 and RX3.

However, in an embodiment, since the transmitting device TX that can determine conditions of all of the receiving devices RX1, RX2, and RX3 can decide the grouping information or the codebook information, the beam toward each receiving device can be exactly formed. For example, the transmitting device TX may determine the conditions of the receiving devices RX1, RX2, and RX3 through the first sounding procedure.

In some embodiments, as shown in FIG. 9 and FIG. 10, the frame body field of the NDPA frame may further include a sounding dialog token. The sounding dialog token includes a value selected by the transmitting device to identify the NDPA frame.

In some embodiments, as shown in FIG. 9 and FIG. 10, the MAC header of the NDPA frame may include a frame control field, a duration field, a receiver address (RA) field, and a transmitter address (TA) field.

The frame control field carries information related to frame control, and the duration field indicates a duration value. The RA field is set to a broadcast address, and the TA field is set to an address of a device transmitting the NDPA frame, i.e., the transmitting device.

In some embodiments, as shown in FIG. 9 and FIG. 10, the MAC frame of the NDPA frame may further include a frame check sequence (FCS) field. The FCS field is located next to the frame body field and may include a cyclic redundancy check (CRC).

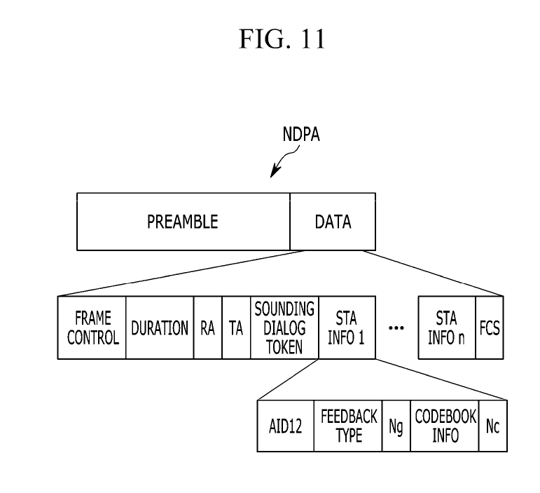

FIG. 11 shows an example of an NDPA frame shown in FIG. 8.

Referring to FIG. 11, an NDPA frame includes a preamble and a data field. In some embodiments, the NDPA frame may have the same format as the NDPA frame shown in FIG. 10.

Each station information field (STA Info) in the NDPA frame includes identification information of a corresponding receiving device, a feedback type, grouping information, and codebook information.

The identification information of the receiving device may include some bits of an AID of the receiving device. The feedback type may indicate any one of OFDMA, SU-MIMO, MU-MIMO, a combination (OFDMA+SU-MIMO) of the OFDMA and the SU-MIMO, or a combination (OFDMA+MU-MIMO) of the OFDMA and the MU-MIMO. When the feedback type indicates MU-MIMO or OFDMA+MU-MIMO, each station information field (STA Info) may further include an Nc index.

The grouping information indicates the number Ng of subcarriers included in a subcarrier grouping used for the compressed beamforming feedback matrix, i.e., one group. The codebook information indicates information on a quantization level of angle information in the compressed beamforming feedback matrix.

In some embodiments, as shown in FIG. 11, the frame body field of the NDPA frame may further include a sounding dialog token.

In some embodiments, as shown in FIG. 11, the MAC header of the NDPA frame may include a frame control field, a duration field, an RA field, and a TA field.

In some embodiments, as shown in FIG. 11, the MAC frame of the NDPA frame may further include an FCS field.

FIG. 12 shows a frame structure in a wireless communication network according to an embodiment.

Referring to FIG. 12, a frame according to an embodiment includes a legacy preamble and a part supporting a wireless communication network according to an embodiment, for example a HE compatible part. The frame shown in FIG. 12 may be a physical layer (PHY) frame, for example a physical layer convergence procedure (PLCP) frame. Further, the frame shown in FIG. 12 may be a downlink frame transmitted by the AP or an uplink frame transmitted by the station. Hereinafter, such a frame format is referred to as a “HE frame format.”

The legacy preamble is provided for backward compatibility with previous version WLAN devices. The legacy preamble includes a legacy short training field (L-STF), a legacy long training field (L-LTF), and a legacy signal field (L-SIG). The L-STF may be used for initial synchronization, signal detection, and automatic gain control. The L-LTF may be used for fine frequency synchronization and channel estimation. The L-SIG may include signaling information such as length information representing a length of the entire frame.

The HE compatible part includes a HE preamble and a data field. The data field includes data to be transmitted, and the data may correspond to a MAC frame. The HE preamble may include a HE preamble 1 and a HE preamble 2.

In some embodiments, a 20 MHz bandwidth may be divided into a plurality of subchannels. While it has been shown in FIG. 12 that the 20 MHz bandwidth is divided into subchannels with a 5 MHz bandwidth, the 20 MHz bandwidth may be divided into subchannels with 2.5 MHz bandwidth or subchannels with 10 MHz bandwidth. In this case, the legacy preamble and the HE preamble 1 may be transmitted by the 20 MHz bandwidth unit, and the HE preamble 2 and data field may be transmitted by the subchannel unit.

The HE preamble 1 includes a HE signal field (HE-SIG-A) following the L-SIG and an additional HE signal field (HE-SIG-B) following to the HE-SIG-A. The HE-SIG-A and HE-SIG-B carry signaling information for a HE device. The length information of the L-SIG and the signaling information of the HE-SIG-A and HE-SIG-B may be decoded based on the channel information estimated by the L-LTF.

The HE preamble 2 may include a HE short training field (HE-STF). The HE-STF may be used for automatic gain control of the HE compatible part and may correspond to one symbol. In some embodiments, the HE-STF may be included in the HE preamble 1.

The HE preamble 2 may further include a HE long training field (HE-LTF). The HE-LTF may be used for channel estimation of the HE compatible part and may follow the HE-STF. The HE-LTF may include a plurality of HE-LTFs. Each of the HE-LTFs may correspond to one symbol, for example, an orthogonal frequency division multiplexing (OFDM) symbol. The data, i.e., the MAC frame part of the data field, may be decoded using the channel information estimated using the HE-LTF.

In some embodiments, the HE-LTF may be used for MIMO channel estimation. The number of HE-LTFs may be determined based on the number of antennas used for the MIMO transmission, i.e., the number of streams. In one embodiment, the stream may be a space-time stream.

The HE preamble 2 may further include an additional HE signal field (HE-SIG-C) following the HE-LTF.

In some embodiments, subcarrier spacing is shortened to increase a length of an OFDM symbol. An FFT having a larger size than an FFT used in the previous WLAN (i.e., a legacy WLAN, an HT WLAN, or a VHT WLAN) may be used.

In some embodiments, the subcarrier spacing that is applied to symbols of a legacy preamble and the HE preamble 1 may be equal to the subcarrier spacing of the previous WLAN, for backward compatibility with the previous WLAN standard. That is, an FFT having the same size as the previous WLAN may be used. The FFT used in the previous WLAN may be a 64 point FFT on a 20 MHz basic bandwidth, wherein the subcarrier spacing used in the previous WLAN is 312.5 kHz. Accordingly, 64 subcarriers per symbol can be used on the 20 MHz basic bandwidth. Each symbol of the legacy preamble and the HE preamble 1 may include a data interval corresponding to an FFT period with 3.2 μs length and a GI that is prepended to the data interval and has the length of 0.4 μs or 0.8 μs. In an embodiment, the GI may be formed using a cyclic prefix (CP) of the data interval. In this case, a 0.4 μs GI may be called ⅛ CP since it is formed by the CP corresponding to ⅛ of 3.2 μs length. A 0.8 μs GI may be called ¼ CP since it is formed by the CP corresponding to ¼ of 3.2 μs length.

In some embodiments, subcarrier spacing narrower than 312.5 kHz may be applied to the HE preamble 2 and the data field. That is, an FFT that has a size larger than 64 FFT on the 20 MHz basic bandwidth may be applied to the HE preamble 2 and the data field. For example, an inverse Fourier transformer (140 of FIG. 2) of a transmitting device may use the FFT having a size larger than a 64 point FFT when performing an IFFT, and a Fourier transformer (230 of FIG. 3) of a receiving device may use a FFT having a size larger than the 64 point FFT when performing a FFT.

In some embodiments, a subcarrier spacing (i.e., 78.125 kHz) that corresponds to ¼ of the subcarrier spacing in the legacy preamble may be used in the HE preamble 2 and the data field. For this, an FFT with four times as many points as the FFT of the legacy preamble (hereinafter, a four times FFT), i.e., a 256 FFT on the 20 MHz basic bandwidth, may be used. Accordingly, 256 subcarriers per symbol can be used on the 20 MHz basic bandwidth. In this case, each symbol has a data interval corresponding to an FFT period of 12.8 μs. Accordingly, a length of symbol duration excluding the GI from each symbol in the HE preamble 2 and the data field becomes four times a length of symbol duration excluding the GI from each symbol in the legacy preamble.

The GI has 0.4 μs length at 1/32 CP, has 0.8 μs length at 1/16 CP, has 1.6 μs length at ⅛ CP, and has 3.2 μs length at ¼ CP. For example, when the ¼ CP is used, symbol duration is 16.0 μs. Accordingly, in the HE compatible part, the symbol can be lengthened and the GI can be lengthened on the same fractional CP basis, compared with the legacy preamble.

In some embodiments, a wireless communication network may use any one among 1/32 CP (0.4 μs GI), 1/16 CP (0.8 μs GI), ⅛ CP (1.6 μs GI), and ¼ CP (3.2 μs GI) while using the 256 point FFT, i.e., 256 subcarriers.

As such, an effect by the inter-symbol interference USD in a large delay environment can be reduced by increasing the length of the symbol.

Next, an NDPA frame of a case that a HE preamble 2 and a data field can use more subcarriers is described.

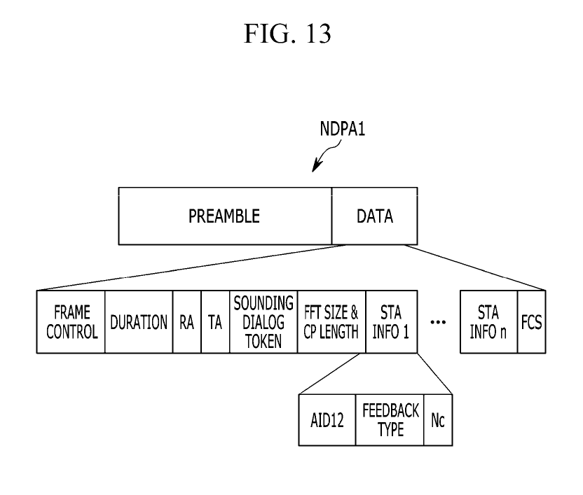

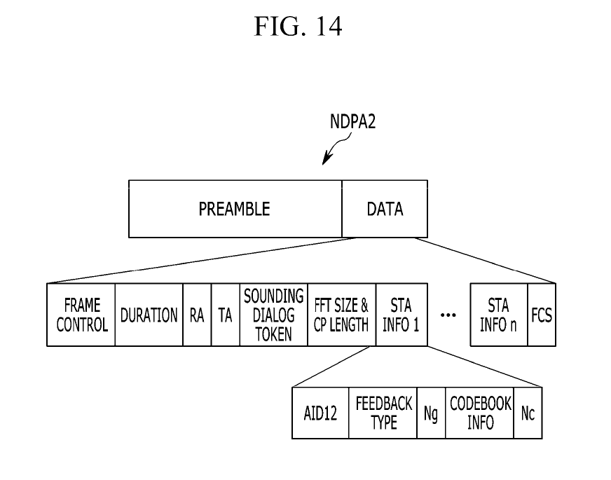

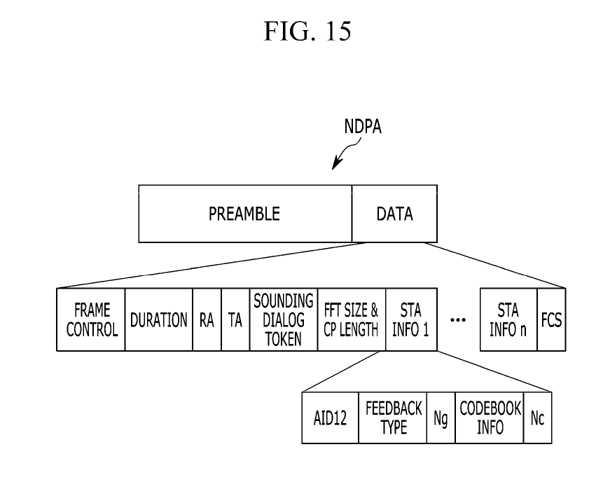

FIG. 13 shows another example of the first NDPA frame shown in FIG. 7, FIG. 14 shows another example of the second NDPA frame shown in FIG. 7, and FIG. 15 shows another example of an NDPA frame shown in FIG. 8.

Referring to FIG. 13 to FIG. 15, a frame body field of a MAC frame included in a data field of an NDPA frame may further FFT size and CP length information.

The FFT size and CP length information may include information on a FFT size (i.e., the number of subcarriers) or a length of a CP (i.e., a length of a GI) to be used in the HE preamble 2 of an NDP frame.

In some embodiments, when the FFT size to be used in the preamble 2 of the NDP frame is predefined, the frame body field of the MAC frame may not include the FFT size information but may include the CP length information.

The CP length information may indicate any one among 1/32 CP, 1/16 CP, ⅛ CP, and ¼ CP. When the FFT size indicates a 256 point FFT on the 20 MHz basic bandwidth, the GI may have 0.4 μs length at the 1/32 CP, 0.8 μs length at the 1/16 CP, 1.6 μs length at the ⅛ CP, and 3.2 μs length at the ¼ CP.

According to above embodiments, since the transmitting device provides the receiving devices with the NDPA frame, the receiving devices can determine feedback information to be fed back to the transmitting device. Further, the receiving devices can determine a format of the NDP frame based on the NDPA frame.

Some information provided by the NDPA frame may be predefined between the transmitting device and the receiving device. In this case, the transmitting device may not provide the predefined information through the NDPA frame. For example, when the Ng index is predefined, the NDPA frame may not include the Ng index.

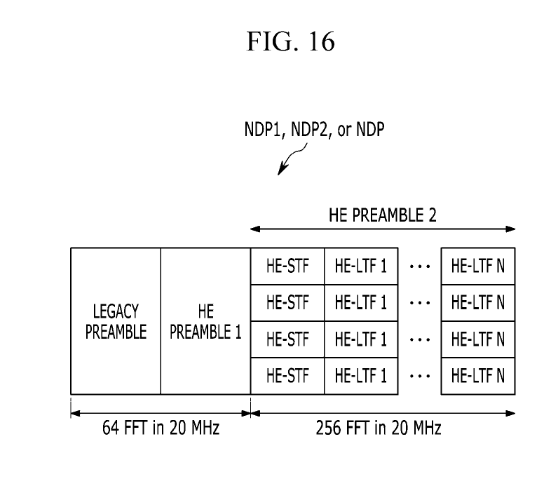

Next, an NDP frame in a wireless communication network according to an embodiment is described with reference FIG. 16 to FIG. 20.

FIG. 16 shows an example of an NDP frame shown in FIG. 7 or FIG. 8.

Referring to FIG. 16, an NDP frame may have a frame format defined by a wireless communication network according to an embodiment, for example a HE WLAN. In some embodiments, the NDP frame may have a format excluding a data field from a frame structure described with reference to FIG. 12. That is, the NDP frame may include a legacy preamble, a HE preamble 1, and a HE preamble 2.

The legacy preamble and the HE preamble 1 may be transmitted by the 20 MHz bandwidth unit and may use a 64 point FFT on the 20 MHz basic bandwidth, for backward compatibility with previous version WLAN devices.

The HE preamble 2 may use an FFT and a GI indicated by FFT size and CP length information of an NDPA frame. In some embodiments, when the NDPA frame does not include the FFT size and CP length information, the HE preamble 2 may use a predefined FFT and GI. In some embodiments, when the NDPA frame does not include the FFT size information, the HE preamble 2 may use the predefined FFT and the GI indicated by the CP length information. For example, the HE preamble 2 may use a 256 point FFT on the 20 MHz basic bandwidth.

The HE preamble 2 may be transmitted by the subchannel unit. For example, when the 20 MHz bandwidth is divided into 5 MHz bandwidths, the HE preamble 2 may be transmitted by the 5 MHz bandwidth unit. The HE preamble 2 may include a HE short training field (HE-STF) and a HE long training field (HE-LTF). Accordingly, each receiving device can measure a subchannel (for example, measure an average SNR in each subchannel) based on the HE-LTF of the first NDP frame (NDP1 of FIG. 7) transmitted by the subchannel unit. Further, each receiving device may determine feedback information for beamforming based on the HE-LTF of the second NDP frame (NDP2 of FIG. 7) transmitted on its allocated subchannel.

In some embodiments, a HE signal field, for example an additional HE signal field (HE-SIG-B), included in the preamble 1 of the second NDP frame NDP2 may include information on the subchannel allocated through the first sounding procedure. That is, the HE-SIG-B may include information on the subchannel allocated to each receiving device. In some embodiments, a HE signal field, for example an additional HE signal field (HE-SIG-B), of a frame transmitted subsequently to a unified sounding procedure shown in FIG. 8 may include information on the subchannel allocated through the unified sounding procedure.

In some embodiments, when the feedback type of the NDPA frame is set to OFDMA+SU-MIMO, or OFDMA+MU-MIMO (i.e., when MIMO transmission is used), the number of HE-LTFs included in the NDP frame may be determined corresponding to the number of antennas (i.e., the number of streams) used in the MIMO transmission. Then, each receiving device can measure each stream based on the corresponding HE-LTF for each stream. When the feedback type of the NDPA frame is set to SU-MIMO, MU-MIMO, OFDMA+SU-MIMO, or OFDMA+MU-MIMO, the number of HE-LTFs included in the NDP frame may be determined corresponding to the number of antennas (i.e., the number of streams) used in the MIMO transmission. Then, each receiving device can determine feedback information of the MIMO transmission based on the corresponding HE-LTF for each stream.

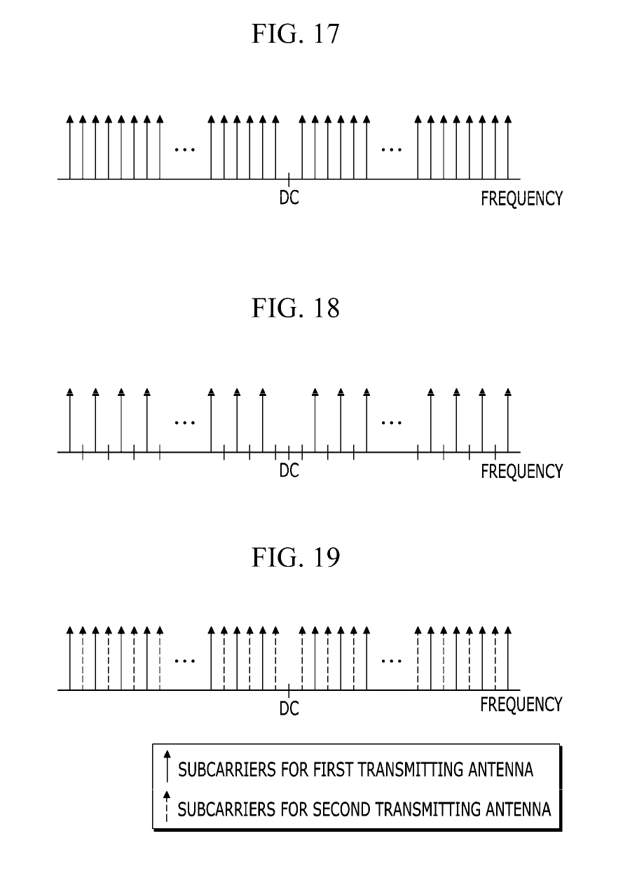

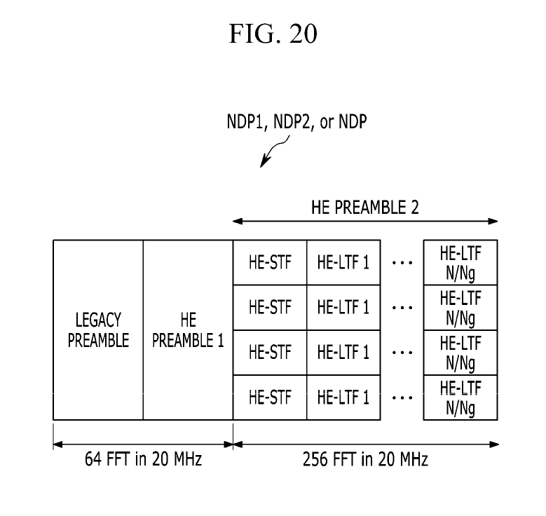

FIG. 17 shows an example of subcarriers used in a HE-LTF in a case that Ng is 1 in an NDP frame shown in FIG. 16, FIG. 18 shows an example of subcarriers used in a HE-LTF in a case that Ng is 2 in an NDP frame shown in FIG. 16, FIG. 19 shows another example of subcarriers used in a HE-LTF in a case that Ng is 2 in an NDP frame shown in FIG. 16, and FIG. 20 shows another example of an NDP frame shown in FIG. 7 or FIG. 8.

Referring to FIG. 17, when Ng is set to 1 in an NDPA frame, a HE-LTF of an NDF frame following the NDPA frame uses all of available subcarriers. Values (for example, non-zero values) for the HE-LTF may be allocated to tones of the available subcarriers.

Generally, the number of subcarriers allocated to a predetermined bandwidth may be determined by a FFT size. For example, when a 256 point FFT is used in a 20 MHz bandwidth, 256 subcarriers may be allocated. When the 20 MHz bandwidth is divided into subchannels with a 5 MHz bandwidth, 64 subcarriers may be allocated to each subchannel. A center subcarrier among the plurality of subcarriers allocated to the bandwidth may be used as a DC (direct current) tone. An index of the center subcarrier used as the DC tone is 0. Some subcarriers that are disposed on both sides of the DC tone whose index is 0 may be also used as DC tones. Some subcarriers that are disposed on both ends from the DC tone may be used as guard tones. Accordingly, remaining subcarriers that exclude the DC tones and the guard tones from the plurality of subcarriers may be used as the available subcarriers. Alternatively, some subcarriers may be used as pilot tones. In this case, remaining subcarriers that exclude the DC tones, the guard tones, and the pilot tones from the plurality of subcarriers may be used as the available subcarriers.

When Ng is not 1, the HE-LTF of the NDP frame uses one subcarrier among grouped subcarriers. For example, when Ng is set to 2, even-numbered subcarriers among the available subcarriers may be used for the HE-LTF as shown in FIG. 18. That is, the values (for example, non-zero values) for the HE-LTF may be allocated to tones of the even-numbered subcarriers, and zeros (i.e., null values) may be allocated to tones of odd-numbered subcarriers. That is, the values for the HE-LTF may be allocated to tones whose indices are [±2,±4,±6, . . . ], and zeros may be allocated to tones whose indices are [±1,±3,±5, . . . ]. In another embodiment, the values for the HE-LTF may be allocated to tones of the odd-numbered subcarriers and zeros may be allocated to tones of the even-numbered subcarriers.

In one embodiment, when Ng is not set to 1, a power of the subcarriers in the HE-LTF may be increased Ng times compared with a power of the subcarriers at Ng set to 1 such that the whole power can match to the whole power of the HE-LTF at Ng set to 1. Further, channel estimation performance can be enhanced by increasing the power.

In another embodiment, in a case that Ng is not set to 1, when an inverse Fourier transformer (140 of FIG. 2) performs an inverse Fourier transform, for example an IFFT, after the value is allocated to one of the grouped subcarriers, a waveform where one waveform is repeated Ng times is ouput. For example, when the 256 point FFT is used and Ng is set to 2, a waveform of 12.8 μs length where a waveform of 6.4 μs length (excluding the GI) is repeated twice is output. That is, a waveform having a 6.4 μs period is output in two periods per symbol. Accordingly, only one period may be transmitted as the HE-LTF among the two periods per symbol. Then, the HE-LTF can be transmitted in the same form as a case that a 128 point FFT is used and Ng is set to 1. That is, if only one period is transmitted as the HE-LTF in the waveform that is output by Ng periods when Ng is not set to 1, symbol duration excluding a GI from each symbol of the HE-LTF may have the same length as symbol duration excluding a GI from a symbol that is output by using an FFT that is 1/Ng the size of the FFT used in the HE preamble 2.

When the FFT having the larger size than the FFT used in the legacy preamble is used in the HE preamble 2, the symbol length is increased. Accordingly, overhead may be increased by the HE-LTF symbols corresponding to the number of streams. However, as described above, since a length of symbol duration excluding the GI from each symbol of the HE-LTF can be decreased 1/Ng, the overhead of the HE-LTF can be decreased.

If Ng is set to 2 when the 256 point FFT is used, the length of symbol duration excluding the GI from each symbol of the HE-LTF is 6.4 μs. Accordingly, it may be characterized that the 128 point FFT is applied to the HE-LTF on the 20 MHz basic bandwidth. Similarly, if Ng is set to 4 when the 256 point FFT is used, the length of symbol duration excluding the GI from each symbol of the HE-LTF is 3.2 μs. Accordingly, it may be characterized that the 64 point FFT is applied to the HE-LTF in the same way as the legacy preamble.

Referring to FIG. 19, in yet another embodiment, when Ng is set to 2, odd-numbered subcarriers may be used for a stream of one transmitting antenna and even-numbered subcarriers may be used for a stream of another transmitting antenna. For example, if Ng is set to 1 when two transmitting antennas (i.e., two streams) are used, two HE-LTF symbols may be used. In this case, if Ng is set to 2, odd-numbered subcarriers of one HE-LTF symbol can be used for one transmitting antenna stream and even-numbered subcarriers of the one HT-LTF symbol can be another transmitting antenna stream. Then, channels of the two transmitting antennas can be estimated by the one HE-LTF symbol. Similarly, if Ng is set to 1 when four transmitting antennas (i.e., four streams) are used, four HE-LTF symbols may be used. In this case, if Ng is set to 2, odd-numbered subcarriers of the first HE-LTF symbol can be used for the first transmitting antenna, even-numbered subcarriers of the first HE-LTF symbol can be used for the second transmitting antenna, odd-numbered subcarriers of the second HE-LTF symbol can be used for the third transmitting antenna, and even-numbered subcarriers of the second HE-LTF symbol can be used for the fourth transmitting antenna. Accordingly, channels of the four transmitting antennas can be estimated by the two HE-LTF symbols.

As such, in a case that N HE-LTF symbols are used at Ng equal to 1, if Ng subcarriers grouped are used for channel estimation of the different transmitting antennas, a sounding procedure can be performed by N/Ng HE-LTF symbols as shown in FIG. 20. Accordingly, the overhead of the HE-LTF can be reduced and the overhead of the GI can be also reduced by the reduced number of HE-LTF symbols.

According to above embodiments, since the transmitting device provides the receiving devices with the NDP frame, the receiving devices can measure the feedback information based on the NDP frame. The overhead of the NDP frame can be reduced by adjusting subcarriers used in the HE-LTF of the NDP frame.

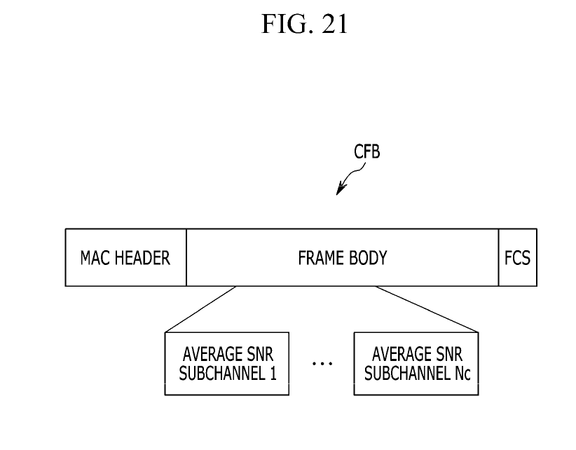

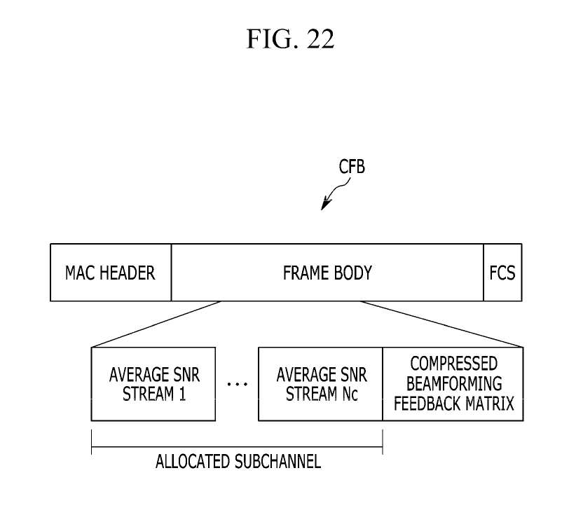

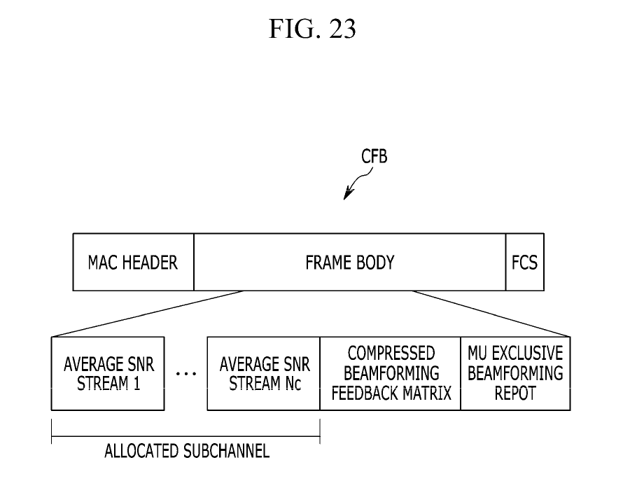

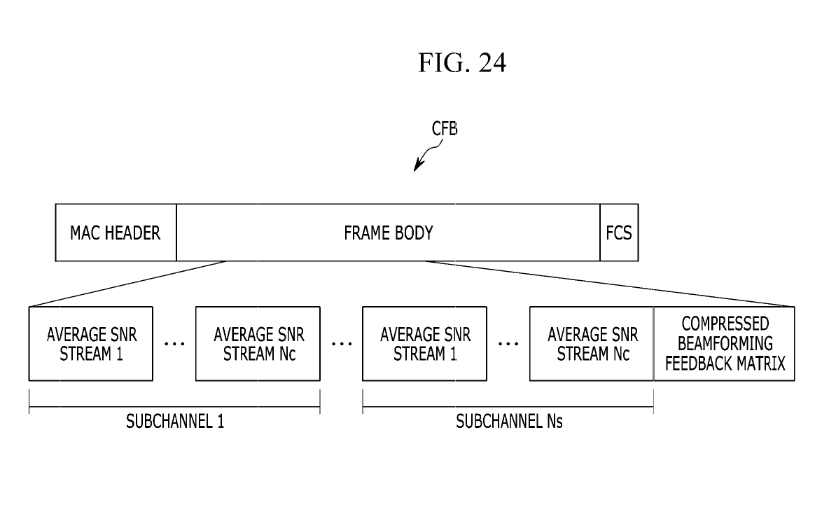

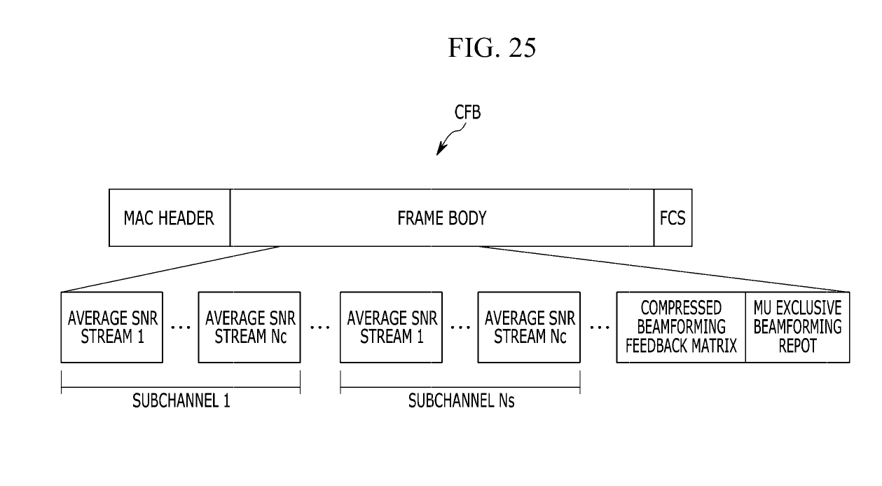

FIG. 21 shows an example of a CFB frame when a feedback type indicates OFDMA, FIG. 22 shows an example of a CFB frame when a feedback type indicates SU-MIMO, FIG. 23 shows an example of a CFB frame when a feedback type indicates MU-MIMO, FIG. 24 shows an example of a CFB frame when a feedback type indicates OFDMA+SU-MIMO, and FIG. 25 shows an example of a CFB frame when a feedback type indicates OFDMA+MU-MIMO.

Referring to FIG. 21 to FIG. 25, in some embodiments, a CFB frame may be a MAC frame including a MAC header, a frame body field, and an FCS field. The frame body field includes feedback information. The MAC frame may be transmitted by being inserted to a data field of a PHY frame.

Referring to FIG. 21, when a feedback type is set to OFDMA, the feedback information of the CFB frame includes subchannel information that is measured on each of a plurality of subchannels. The receiving device may measure its subchannel information based on a HE-LTF of an NDP frame. In one embodiment, the subchannel information for the subchannel may include an average signal-to-noise ratio (SNR). That is, the feedback information of the CFB frame may include the average SNR for each subchannel. When the number of subchannels is Ns, the feedback information includes an average SNR of subchannel 1, an average SNR of subchannel 2, . . . , an average SNR of subchannel Ns.

The average SNR of subchannel i may be obtained by calculating SNRs per subcarrier for a plurality of subcarriers of subchannel i and calculating an arithmetic mean of the SNRs per subcarrier. In some embodiments, when a plurality of streams are used, the average SNR of subchannel i may be calculated by averaging arithmetic means of the SNRs per subcarrier for the plurality of space-time streams.

Referring to FIG. 22, when the feedback type is set to SU-MIMO, the feedback information of the CFB frame includes subchannel information of a subchannel allocated to a corresponding receiving device for each of a plurality of streams. In one embodiment, the subchannel information may include an average signal-to-noise ratio (SNR) of the subchannel. That is, the feedback information of the CFB frame may include the average SNR for each stream at the allocated subchannel.

For example, it is assumed that a subchannel 1 is allocated to a receiving device RX1, subchannels 2 and 3 are allocated to a receiving device RX2, a subchannel 4 is allocated to a receiving device RX3, and the number of streams is Nc. The feedback information of the CFB frame fed back by the receiving device RX1 includes the average SNR for each stream at the subchannel 1, i.e., the average SNR of a stream 1 at the subchannel 1, the average SNR of a stream 2 at the subchannel 1, . . . , the average SNR of a stream Nc at the subchannel 1. The feedback information of the CFB frame fed back by the receiving device RX2 includes the average SNR for each stream at the subchannel 2 and the average SNR for each stream at the subchannel 3, and the feedback information of the CFB frame fed back by the receiving device RX3 includes the average SNR for each stream at the subchannel 4.

The feedback information of the CFB frame further includes beamforming feedback matrix information. In one embodiment, the beamforming feedback matrix information may be compressed beamforming feedback matrix information. The compressed beamforming feedback matrix information may be provided in the form of angles representing compressed beamforming feedback matrices for use by the transmitting device to determine steering matrices.

Referring to FIG. 23, when the feedback type is set to MU-MIMO, the feedback information of the CFB frame includes subchannel information of a subchannel allocated to a corresponding receiving device for each of a plurality of streams. In one embodiment, the subchannel information may include an average signal-to-noise ratio (SNR) of the subchannel. That is, the feedback information of the CFB frame may include the average SNR for each stream at the allocated subchannel.

The feedback information of the CFB frame further includes beamforming feedback matrix information and MU exclusive beamforming report information, for MU-MIMO transmission. In one embodiment, the beamforming feedback matrix information may be compressed beamforming feedback matrix information, and the compressed beamforming feedback matrix information may be provided in the form of angles representing compressed beamforming feedback matrices. In one embodiment, MU exclusive beamforming report information may include SNR information per subcarrier for each stream. When Ng is not set to 1, the SNR information per subcarrier may be measured only on subcarriers used in the HE-LTF of the NDP frame. The transmitting device may determine a steering matrix for the MU-MIMO transmission based on the compressed beamforming feedback matrix information and the MU exclusive beamforming report information.

Referring to FIG. 24, when the feedback type is set to OFDMA+SU-MIMO, the feedback information of the CFB frame includes subchannel information per stream for each subchannel. In one embodiment, the subchannel information may include an average SNR of the subchannel. That is, the feedback information of the CFB frame may include the average SNR per stream for each subchannel. When the number of subchannels is Ns, the feedback information of the CFB frame includes the average SNR per stream at subchannel 1, the average SNR per stream at subchannel 2, . . . , the average SNR per stream at subchannel Ns. The average SNR per stream at each subchannel include the average SNR of scream 1 at the corresponding subchannel, the average SNR of scream 2 at the corresponding subchannel, . . . , the average SNR of scream Nc at the corresponding subchannel.

The feedback information of the CFB frame further includes beamforming feedback matrix information. In one embodiment, the beamforming feedback matrix information may be compressed beamforming feedback matrix information. The compressed beamforming feedback matrix information may be provided in the form of angles representing compressed beamforming feedback matrices for use by the transmitting device to determine steering matrices.

Referring to FIG. 25, when the feedback type is set to OFDMA+MU-MIMO, the feedback information of the CFB frame includes subchannel information per stream for each subchannel. In one embodiment, the subchannel information may include an average SNR of the subchannel. That is, the feedback information of the CFB frame may include the average SNR per stream for each subchannel.

The feedback information of the CFB frame further includes beamforming feedback matrix information and MU exclusive beamforming report information, for MU-MIMO transmission. In one embodiment, the beamforming feedback matrix information may be compressed beamforming feedback matrix information, and the compressed beamforming feedback matrix information may be provided in the form of angles representing compressed beamforming feedback matrices. In one embodiment, MU exclusive beamforming report information may include SNR information per subcarrier for each stream. When Ng is not set to 1, the SNR information per subcarrier may be measured only on subcarriers used in the HE-LTF of the NDP frame. The transmitting device may determine a steering matrix for the MU-MIMO transmission based on the compressed beamforming feedback matrix information and the MU exclusive beamforming report information.

In some embodiments, the compressed beamforming feedback matrix information may be feedback information that is provided in the form of angles representing compressed beamforming feedback matrices in a VHT compressed beamforming report field defined in the IEEE standard 802.11ac. For example, the number (Na) of angles and the angles (φ, ψ) representing the compressed beamforming feedback matrix may be defined as in Table 1 in accordance with the size (Nr×Nc) of beamforming feedback matrix V.

TABLE 1

| Size of V | Number of | The order of angles in the Compressed Beamforming Feedback |
|---|---|---|
| (Nr × Nc) | angles (Na) | Matrix subfield |
| 2 × 1 | 2 | φ11, ψ21 |
| 2 × 2 | 2 | φ11, ψ21 |
| 3 × 1 | 4 | φ11, φ21, ψ21, ψ31 |
| 3 × 2 | 6 | φ11, φ21, ψ21, ψ31, φ22, ψ32 |
| 3 × 3 | 6 | φ11, φ21, ψ21, ψ31, φ22, ψ32 |
| 4 × 1 | 6 | φ11, φ21, φ31, ψ21, ψ31, ψ41 |
| 4 × 2 | 10 | φ11, φ21, φ31, ψ21, ψ31, ψ41, φ22, φ32, ψ32, ψ42 |
| 4 × 3 | 12 | φ11, φ21, φ31, ψ21, ψ31, ψ41, φ22, φ32, ψ32, ψ42, φ33, ψ43 |
| 4 × 4 | 12 | φ11, φ21, φ31, ψ21, ψ31, ψ41, φ22, φ32, ψ32, ψ42, φ33, ψ43 |
| 5 × 1 | 8 | φ11, φ21, φ31, φ41, ψ21, ψ31, ψ41, ψ51 |
| 5 × 2 | 14 | φ11, φ21, φ31, φ41, ψ21, ψ31, ψ41, ψ51, φ22, φ32, φ42, ψ32, |
| | | ψ42, ψ52 |
| 5 × 3 | 18 | φ11, φ21, φ31, φ41, ψ21, ψ31, ψ41, ψ51, φ22, φ32, φ42, ψ32, |
| | | ψ42, ψ52, φ33, φ43, ψ43, ψ53 |
| 5 × 4 | 20 | φ11, φ21, φ31, φ41, ψ21, ψ31, ψ41, ψ51, φ22, φ32, φ42, ψ32, |
| | | ψ42, ψ52, φ33, φ43, ψ43, ψ53, φ44, ψ54 |
| 5 × 5 | 20 | φ11, φ21, φ31, φ41, ψ21, ψ31, ψ41, ψ51, φ22, φ32, φ42, ψ32, |
| | | ψ42, ψ52, φ33, φ43, ψ43, ψ53, φ44, ψ54 |
| 6 × 1 | 10 | φ11, φ21, φ31, φ41, φ51, ψ21, ψ31, ψ41, ψ51, ψ61 |
| 6 × 2 | 18 | φ11, φ21, φ31, φ41, φ51, ψ21, ψ31, ψ41, ψ51, ψ61, φ22, φ32, |
| | | φ42, φ52, ψ32, ψ42, ψ52, ψ62 |
| 6 × 3 | 24 | φ11, φ21, φ31, φ41, φ51, ψ21, ψ31, ψ41, ψ51, ψ61, φ22, φ32, |
| | | φ42, φ52, ψ32, ψ42, ψ52, ψ62, φ33, φ43, φ53, ψ43, ψ53, ψ63 |
| 6 × 4 | 28 | φ11, φ21, φ31, φ41, φ51, ψ21, ψ31, ψ41, ψ51, ψ61, φ22, φ32, |
| | | φ42, φ52, ψ32, ψ42, ψ52, ψ62, φ33, φ43, φ53, ψ43, ψ53, ψ63, |
| | | φ44, φ54, ψ54, ψ64 |
| 6 × 5 | 30 | φ11, φ21, φ31, φ41, φ51, ψ21, ψ31, ψ41, ψ51, ψ61, φ22, φ32, |
| | | φ42, φ52, ψ32, ψ42, ψ52, ψ62, φ33, φ43, φ53, ψ43, ψ53, ψ63, |
| | | φ44, φ54, ψ54, ψ64, φ55, ψ65 |
| 6 × 6 | 30 | φ11, φ21, φ31, φ41, φ51, ψ21, ψ31, ψ41, ψ51, ψ61, φ22, φ32, |
| | | φ42, φ52, ψ32, ψ42, ψ52, ψ62, φ33, φ43, φ53, ψ43, ψ53, ψ63, |
| | | φ44, φ54, ψ54, ψ64, φ55, ψ65 |
| 7 × 1 | 12 | φ11, φ21, φ31, φ41, φ51, φ61, ψ21, ψ31, ψ41, ψ51, ψ61, ψ71 |
| 7 × 2 | 22 | φ11, φ21, φ31, φ41, φ51, φ61, ψ21, ψ31, ψ41, ψ51, ψ61, ψ71, |
| | | φ22, φ32, φ42, φ52, φ62, ψ32, ψ42, ψ52, ψ62, ψ72 |
| 7 × 3 | 30 | φ11, φ21, φ31, φ41, φ51, φ61, ψ21, ψ31, ψ41, ψ51, ψ61, ψ71, |
| | | φ22, φ32, φ42, φ52, φ62, ψ32, ψ42, ψ52, ψ62, ψ72, φ33, φ43, |
| | | φ53, φ63, ψ43, ψ53, ψ63, ψ73 |
| 7 × 4 | 36 | φ11, φ21, φ31, φ41, φ51, φ61, ψ21, ψ31, ψ41, ψ51, ψ61, ψ71, |
| | | φ22, φ32, φ42, φ52, φ62, ψ32, ψ42, ψ52, ψ62, ψ72, φ33, φ43, |
| | | φ53, φ63, ψ43, ψ53, ψ63, ψ73, φ44, φ54, φ64, ψ54, ψ64, ψ74 |
| 7 × 5 | 40 | φ11, φ21, φ31, φ41, φ51, φ61, ψ21, ψ31, ψ41, ψ51, ψ61, ψ71, |
| | | φ22, φ32, φ42, φ52, φ62, ψ32, ψ42, ψ52, ψ62, ψ72, φ33, φ43, |
| | | φ53, φ63, ψ43, ψ53, ψ63, ψ73, φ44, φ54, φ64, ψ54, ψ64, ψ74, |
| | | φ55, φ65, ψ65, ψ75 |
| 7 × 6 | 42 | φ11, φ21, φ31, φ41, φ51, φ61, ψ21, ψ31, ψ41, ψ51, ψ61, ψ71, |
| | | φ22, φ32, φ42, φ52, φ62, ψ32, ψ42, ψ52, ψ62, ψ72, φ33, φ43, |
| | | φ53, φ63, ψ43, ψ53, ψ63, ψ73, φ44, φ54, φ64, ψ54, ψ64, ψ74, |
| | | φ55, φ65, ψ65, ψ75, φ66, ψ76 |
| 7 × 7 | 42 | φ11, φ21, φ31, φ41, φ51, φ61, ψ21, ψ31, ψ41, ψ51, ψ61, ψ71, |
| | | φ22, φ32, φ42, φ52, φ62, ψ32, ψ42, ψ52, ψ62, ψ72, φ33, φ43, |
| | | φ53, φ63, ψ43, ψ53, ψ63, ψ73, φ44, φ54, φ64, ψ54, ψ64, ψ74, |
| | | φ55, φ65, ψ65, ψ75, φ66, ψ76 |
| 8 × 1 | 14 | φ11, φ21, φ31, φ41, φ51, φ61, φ71, ψ21, ψ31, ψ41, ψ51, ψ61, |
| | | ψ71, ψ81 |
| 8 × 2 | 26 | φ11, φ21, φ31, φ41, φ51, φ61, φ71, ψ21, ψ31, ψ41, ψ51, ψ61, |
| | | ψ71, ψ81, φ22, φ32, φ42, φ52, φ62, φ72, ψ32, ψ42, ψ52, ψ62, |
| | | ψ72, ψ82 |
| 8 × 3 | 36 | φ11, φ21, φ31, φ41, φ51, φ61, φ71, ψ21, ψ31, ψ41, ψ51, ψ61, |
| | | ψ71, ψ81, φ22, φ32, φ42, φ52, φ62, φ72, ψ32, ψ42, ψ52, ψ62, |
| | | ψ72, ψ82, φ33, φ43, φ53, φ63, φ73, ψ43, ψ53, ψ63, ψ73, ψ83 |
| 8 × 4 | 44 | φ11, φ21, φ31, φ41, φ51, φ61, φ71, ψ21, ψ31, ψ41, ψ51, ψ61, |
| | | ψ71, ψ81, φ22, φ32, φ42, φ52, φ62, φ72, ψ32, ψ42, ψ52, ψ62, |
| | | ψ72, ψ82, φ33, φ43, φ53, φ63, φ73, ψ43, ψ53, ψ63, ψ73, |
| | | ψ83, □φ44, φ54, φ64, φ74, ψ54, ψ64, ψ74, ψ84 |
| 8 × 5 | 50 | φ11, φ21, φ31, φ41, φ51, φ61, φ71, ψ21, ψ31, ψ41, ψ51, ψ61, |
| | | ψ71, ψ81, φ22, φ32, φ42, φ52, φ62, φ72, ψ32, ψ42, ψ52, ψ62, |
| | | ψ72, ψ82, φ33, φ43, φ53, φ63, φ73, ψ43, ψ53, ψ63, ψ73, |
| | | ψ83, □φ44, φ54, φ64, φ74, ψ54, ψ64, ψ74, ψ84, φ55, φ65, φ75, |
| | | ψ65, ψ75, ψ85 |
| 8 × 6 | 54 | φ11, φ21, φ31, φ41, φ51, φ61, φ71, ψ21, ψ31, ψ41, ψ51, ψ61, |
| | | ψ71, ψ81, φ22, φ32, φ42, φ52, φ62, φ72, ψ32, ψ42, ψ52, ψ62, |
| | | ψ72, ψ82, φ33, φ43, φ53, φ63, φ73, ψ43, ψ53, ψ63, ψ73, |
| | | ψ83, □φ44, φ54, φ64, φ74, ψ54, ψ64, ψ74, ψ84, φ55, φ65, φ75, |
| | | ψ65, ψ75, ψ85, φ66, φ76, ψ76, ψ86 |
| 8 × 7 | 56 | φ11, φ21, φ31, φ41, φ51, φ61, φ71, ψ21, ψ31, ψ41, ψ51, ψ61, |
| | | ψ71, ψ81, φ22, φ32, φ42, φ52, φ62, φ72, ψ32, ψ42, ψ52, ψ62, |
| | | ψ72, ψ82, φ33, φ43, φ53, φ63, φ73, ψ43, ψ53, ψ63, ψ73, |
| | | ψ83, □φ44, φ54, φ64, φ74, ψ54, ψ64, ψ74, ψ84, φ55, φ65, φ75, |
| | | ψ65, ψ75, ψ85, φ66, φ76, ψ76, ψ86, φ77, ψ87 |
| 8 × 8 | 56 | φ11, φ21, φ31, φ41, φ51, φ61, φ71, ψ21, ψ31, ψ41, ψ51, ψ61, |
| | | ψ71, ψ81, φ22, φ32, φ42, φ52, φ62, φ72, ψ32, ψ42, ψ52, ψ62, |
| | | ψ72, ψ82, φ33, φ43, φ53, φ63, φ73, ψ43, ψ53, ψ63, ψ73, |
| | | ψ83, □φ44, φ54, φ64, φ74, ψ54, ψ64, ψ74, ψ84, φ55, φ65, φ75, |
| | | ψ65, ψ75, ψ85, φ66, φ76, ψ76, ψ86, φ77, ψ87 |

In some embodiments, since an NDPA frame provides codebook information, the receiving device may determine angle information (ψ, φ) based on a quantization level of the angle information included in a codebook entry indicated by the codebook information. In one embodiment, the angle information (ψ, φ) may be quantized in Equations 1 and 2.

$$\begin{matrix}ψ = \frac{k π}{{2}^{{b}_{ψ} + 1}} + \frac{π}{{2}^{{b}_{ψ} + 2}} radians \\ where k = 0 , 1 , … , {2}^{{b}_{ψ}} - 1 & Equation 1 \\ φ = \frac{k π}{{2}^{{b}_{φ} - 1}} + \frac{π}{{2}^{{b}_{φ}}} radians \\ where k = 0 , 1 , … , {2}^{{b}_{φ}} - 1 & Equation 2\end{matrix}$$

In Equations 1 and 2, b_{ψ} is the number of bits used to quantize the angle ψ and defined by the codebook information, and b_{φ} is the number of bits used to quantize the angle φ and defined by the codebook information.

According to above embodiments, since the receiving device can provide necessary feedback information based on the feedback type of the NDPA frame transmitted by the transmitting device, the overhead of the CFB frame can be reduced.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims. Further, two or more embodiments may be combined.

What is claimed is:

1. A sounding method of a receiving device, the method comprising:
receiving a null data packet announcement (NDPA) frame including feedback type information from a transmitting device;
receiving a null data packet (NDP) frame from the transmitting device after receiving the NPDA frame; and
transmitting to the transmitting device a channel feedback frame including feedback information according to a feedback type indicated by the feedback type information after receiving the NDP frame.

2. The method of claim 1, wherein the NDPA frame further includes grouping information indicating how many subcarriers are grouped to be fed back as single information.

3. The method of claim 2, wherein, when the grouping information indicates that N subcarriers are grouped to be fed back as the single information, in a long training field of the NDP frame, a value for the long training field is transmitted through only one subcarrier among the N subcarriers.

4. The method of claim 2, wherein, when the grouping information indicates that N subcarriers are grouped to be fed back as the single information, in a long training field of the NDP frame, values for different transmitting antennas are transmitted through the Ng subcarriers, respectively.

5. The method of claim 1, wherein the NDPA frame further includes size information of a fast Fourier transform (FFT) used in a part of the NDP frame or length information of a guard interval used in the part of the NDP frame.

6. The method of claim 5, wherein the part of the NDP frame includes a long training field of the NDP frame.

7. The method of claim 1, wherein the NDPA frame further includes codebook information,
wherein the feedback information includes beamforming feedback matrix information that is provided in a form of angles that are determined based on a quantization level indicated by the codebook information, and
wherein the beamforming feedback matrix information is used for determining a matrix for multiple input multiple output (MIMO) transmission.

8. The method of claim 1, wherein, when the feedback type indicated by the feedback type information is orthogonal frequency division multiple access (OFDMA) transmission, the feedback information, when a predetermined band is divided into a plurality of subchannels, includes an average signal-to-noise ratio (SNR) for each of the subchannels.

9. The method of claim 8, further comprising:
receiving from the transmitting device a second NDPA frame including feedback type information indicating MIMO transmission;
receiving a second NDP frame from the transmitting device after receiving the second NPDA frame; and
transmitting to the transmitting device a second channel feedback frame including feedback information for the MIMO transmission after receiving the second NDP frame,
wherein the feedback information includes beamforming feedback matrix information at a subchannel that is allocated to the receiving device among the plurality of subchannels, and the beamforming feedback matrix information is used for determining a matrix for the MIMO transmission.

10. The method of claim 9, wherein, when the MIMO transmission is multi-user MIMO (MU-MIMO) transmission, the feedback information further includes SNR information per subcarrier for each stream, and
wherein the matrix for the MU-MIMO transmission is determined based on the beamforming feedback matrix information and the SNR information per subcarrier.

11. The method of claim 9, wherein the second NDP frame includes information on a subchannel allocated to the receiving device.

12. The method of claim 1, wherein, when the feedback type indicated by the feedback type information is OFDMA and MIMO transmission, the feedback information, when a predetermined band is divided into a plurality of subchannels, includes an average SNR for each subchannel and beamforming feedback matrix information for each subchannel, and
wherein the beamforming feedback matrix information is used for a matrix for the MIMO transmission.

13. The method of claim 12, wherein, when the MIMO transmission is MU-MIMO transmission, the feedback information further includes SNR information per subcarrier for each stream, and
wherein the matrix for the MU-MIMO transmission is determined based on the beamforming feedback matrix information and the SNR information per subcarrier.

14. A sounding method of a transmitting device, the method comprising:
transmitting to a plurality of receiving devices a null data packet announcement (NDPA) frame including a plurality of feedback type information;
transmitting a null data packet (NDP) frame to the plurality of devices after transmitting the NPDA frame; and
receiving from the plurality of receiving devices channel feedback frames, each of the channel feedback frames including feedback information according to a feedback type indicated by corresponding feedback type information.

15. The method of claim 14, wherein the NDPA frame further includes grouping information indicating how many subcarriers are grouped to be fed back as single information.

16. The method of claim 14, wherein the NDPA frame further includes size information of a fast Fourier transform (FFT) used in a part of the NDP frame or length information of a guard interval used in the part of the NDP frame.

17. The method of claim 14, wherein the NDPA frame further includes a plurality of codebook information respectively corresponding to the plurality of receiving devices,
wherein the feedback information includes beamforming feedback matrix information that is provided in a form of angles that are determined based on a quantization level indicated by a corresponding codebook information among the plurality of codebook information, and
wherein the beamforming feedback matrix information is used for determining a matrix for multiple input multiple output (MIMO) transmission.

18. The method of claim 14, wherein, when the feedback type indicated by the corresponding feedback type information is orthogonal frequency division multiple access (OFDMA) transmission, the feedback information, when a predetermined band is divided into a plurality of subchannels, includes an average signal-to-noise ratio (SNR) for each of the subchannels.

19. The method of claim 18, further comprising:
transmitting to the plurality of receiving devices a second NDPA frame including feedback type information indicating MIMO transmission;
transmitting a second NDP frame to the plurality of receiving devices after transmitting the second NPDA frame; and
receiving from the plurality of receiving devices second channel feedback frames each including feedback information for the MIMO transmission,
wherein the feedback information includes beamforming feedback matrix information at a subchannel that is allocated to a corresponding receiving device among the plurality of subchannels, and the beamforming feedback matrix information is used for determining a matrix for the MIMO transmission.

20. The method of claim 14, wherein, when the feedback type indicated by the corresponding feedback type information is OFDMA and MIMO transmission, the feedback information, when a predetermined band is divided into a plurality of subchannels, includes an average SNR for each subchannel and beamforming feedback matrix information for each subchannel, and
wherein the beamforming feedback matrix information is used for a matrix for the MIMO transmission.
